(19) United States
(12) Patent Application Publication
(10) Pub. No.: US 2020/0392789 A1
(43) Pub. Date: Dec. 17, 2020

(54) LADDER CARRIER

(71) Applicant: James Todd, Toledo, OH (US)

(72) Inventor: James Todd, Toledo, OH (US)

(21) Appl. No.: 16/899,668

(22) Filed: Jun. 12, 2020

Related U.S. Application Data
(60) Provisional application No. 62/860,434, filed on Jun. 12, 2019.

(51) Int. Cl. E06C 7/14

(52) U.S. Cl. CPC E06C 7/14

(57) ABSTRACT

A portable carrier including a primary member disposed between a pair of spools. The primary member having an anterior face and a posterior face, the anterior face having a plurality of hooks extending therefrom and the posterior face having a plurality of straps attached thereto. A singular strap is disposed between each of the duality of spools and has a shoulder hold generally positioned upon any point along the strap. The strap may be elongated to allow for user engagement, and may also be tautly retracted to rest upon a top-most portion of the primary member to aid in storage purposes. Each of the plurality of hooks engages a ladder to aid in weight distribution and mobility of the transport of the ladder.

### CROSS-REFERENCE TO RELATED PATENT APPLICATIONS

This patent application claims the benefit of U.S. Provisional Patent Application Ser. No. 62/860,434, filed on Jun. 12, 2019. The entirety of the disclosure of the above patent application is hereby incorporated herein by reference.

### FIELD OF THE INVENTION

The present invention relates to a carrier. In particular, the invention is directed to a portable ladder carrier configured to engage a ladder, affording a single individual the capability to transport the ladder in either a vertical or horizontal orientation through use of a strap, while also providing the additional capability of the ladder carrier to attach and rest upon the ladder when the carrier is not in use.

### BACKGROUND OF THE INVENTION

Ladders are a highly utilized tool, commonly used within a broad spectrum extending from commercial construction sites to daily household chores. Due to this range of use, a large disparity in ladder size measurements is prevalent, which creates a wide range of issues in how to properly transport the ladder. The most common manner in which ladders are currently being transported, particularly larger ladders, is through the use of two people in order to appropriately distribute the length and weight of the ladder. However, often times the availability of a second person to assist in the transportation of the ladder is sparse. In cases where assistance is not present, an individual person will commonly hoist the ladder upon their own shoulder, resting the ladder upon their collar bone which may lead to negative health-related developments. Other common ways in which ladders are transported may also lead to negative health-related developments regarding a person's arms and wrists. Directly correlative, the longer the ladder is, the heavier the ladder generally is, which affects the weight distribution of the ladder as the point of balance shifts, which also creates an issue with of maneuverability. Thus, it is desirable to provide a portable ladder carrier that may be utilized by a single person, providing the ability to transport a ladder in either a horizontal or vertical orientation while maintaining consistent weight distribution to afford the person the ability to accurately maneuver themselves with the ladder throughout the transportation of the ladder.

Ladders are also obstructive devices due to their generally large sizes. Due to the size constraints ladders generally pose, storing ladders are generally a hassle for people to find adequate spaces for. To add an additional component to the ladder, such as the ladder carrier, would only add to the clutter. Therefore, it is also desirable to provide a portable ladder carrier that may be stored directly onto the ladder or other areas of a storage unit, such as the walls.

### SUMMARY OF THE INVENTION

In concordance and agreement with the instant disclosure, a new carrier configured to engage a ladder to allow for easy transport of the ladder, has surprisingly been discovered.

In one embodiment, a portable carrier comprises a primary member; a plurality of hooks coupled to the primary member, the hooks configured to engage a ladder; and a strap coupled to the primary member, the strap configured to be supported by a shoulder of a user to aid in supporting the ladder.

In another embodiment, the portable carrier comprises a primary member; a plurality of hooks coupled to the primary member, the hooks configured to engage a ladder; a carrier strap coupled to the primary member, the carrier strap configured to be supported by a shoulder of a user to aid in supporting the ladder; and a plurality of securement straps coupled to the primary member to aid in storage of the portable carrier or further securement of the ladder to the carrier.

In yet another embodiment, the portable carrier comprises a primary member having opposing ends; a plurality of hooks coupled to the primary member, the hooks configured to engage a ladder; a carrier strap coupled to the primary member, the carrier strap configured to be supported by a shoulder of a user to aid in supporting the ladder; and a duality of spools oppositely arranged on the opposing ends of the primary member, at least one of the spools including a reel disposed therein to extend and retract the carrier strap.

### BRIEF DESCRIPTION OF THE DRAWINGS

The above-mentioned, and other features and objects of the invention, and the manner of attaining them will become more apparent and the invention itself will be better understood by reference to the following description of an embodiment of the invention taken in conjunction with the accompanying drawings, wherein:

FIG. 1 is a front elevational view of a ladder carrier according to an embodiment;

FIG. 2 is a rear elevational view of the ladder carrier of FIG. 1;

FIG. 3 is a front elevational view of the ladder carrier of FIG. 1 illustrating a horizontally secured ladder;

FIG. 4 is a cross-sectional elevational view of the ladder carrier of FIG. 1 absent a duality of spools and a strap taken along line 4-4;

FIG. 5 is a cross-sectional elevational view of a hook of the ladder carrier of FIG. 1;

FIG. 6 is a perspective view of another embodiment of the ladder carrier;

FIG. 7 is a perspective view of the ladder carrier of FIG. 6 an installation of a hook;

FIG. 8 is a right side elevational view of the hook of FIG. 7 in a folded orientation;

FIG. 9 is a perspective view of another embodiment of the ladder carrier;

FIG. 10 is a perspective view of the ladder carrier of FIG. 9 illustrating hooks in a folded orientation; and

FIG. 11 is an enlarged fragmentary perspective view of a portion of the hook of FIG. 9.

### DETAILED DESCRIPTION OF THE PREFERRED EMBODIMENT

The following detailed description and appended drawings describe and illustrate various exemplary embodiments of the invention. The description and drawings serve to enable one skilled in the art to make, and use the invention, and are not intended to limit the scope of the invention in any manner. With respect to the methods disclosed, the steps presented are exemplary in nature, and thus, the order of the steps is not necessary or critical.

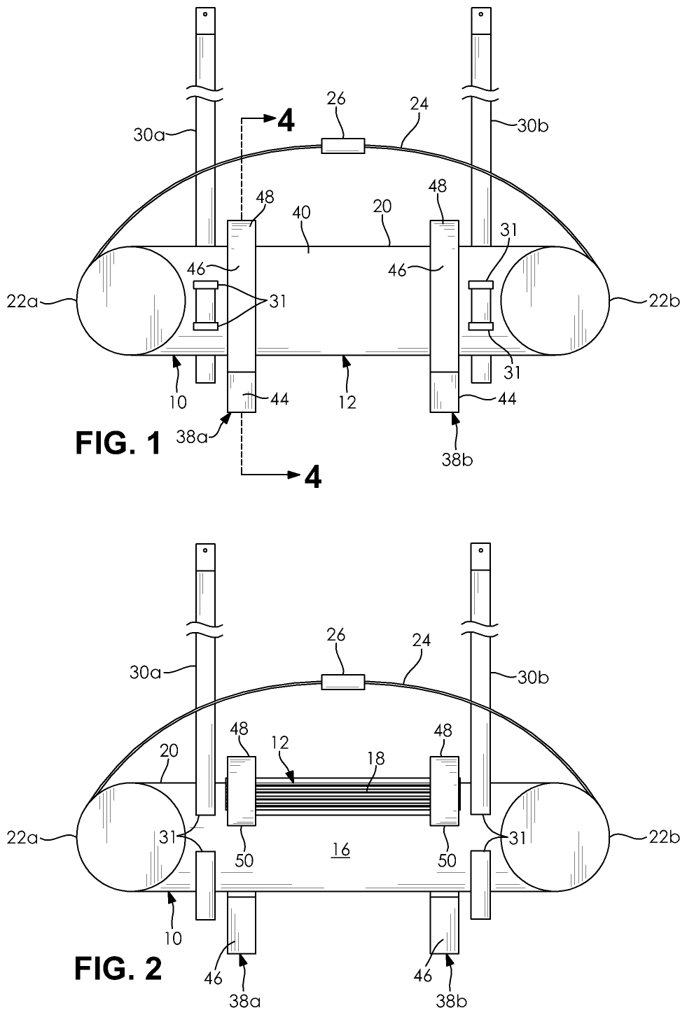

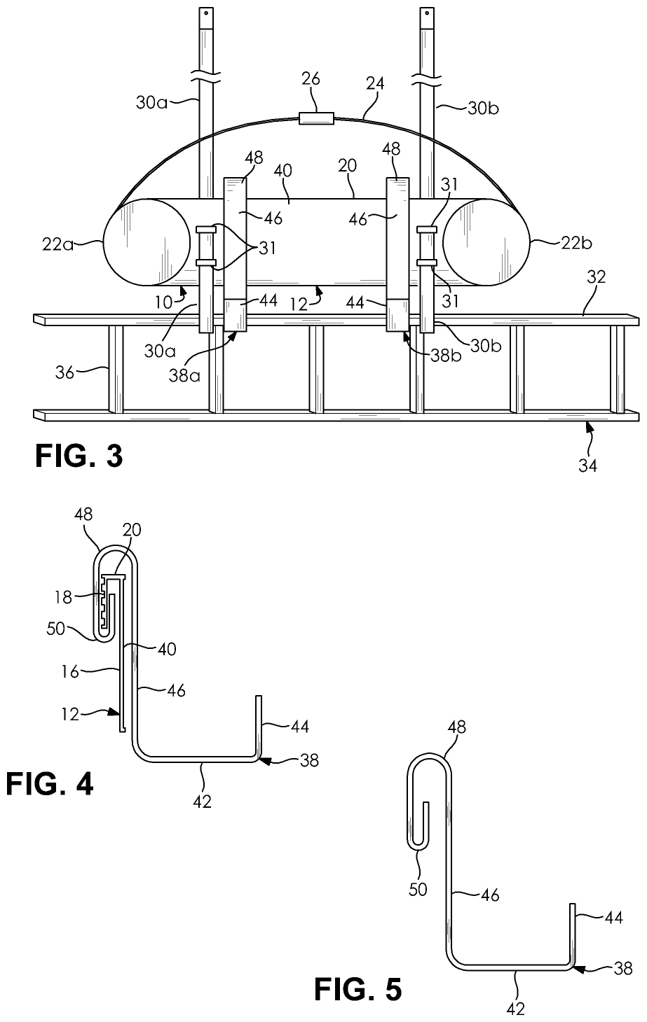

FIGS. 1-3 illustrate a portable carrier 10 according to an embodiment of the disclosure. The portable carrier 10 is formed from a primary member or main body 12. As shown, the primary member 12 is about 18 inches long and six inches tall. However, it is understood that the primary member 12 may have any length, height, and thoickness, as desired. A top-most portion or upper edge 20 of the primary member 12 extends adjacent a posterior face 16 of the primary member 12 and is adjoined to a parallel wall 18.

As shown, the primary member 12 is disposed between a duality of spools 22a, 22b. The duality of spools 22a, 22b house a singular retractable nylon carrier strap 24 including of a shoulder hold or pad 26. The shoulder hold 26 is disposed generally in the middle of the strap 24. However, it is understood that any material may be used to form the strap 24, such as leather or flax. It is also understood that the shoulder hold 26 may be disposed upon any portion along the strap 24 or may be moveable to permit moving the shoulder hold 26 to any point as desired along the strap 24. It is further understood that multiple straps may be used, for example a pair of straps may attach directly to the shoulder hold 26 to form the strap 24 by means of hook and loop straps or stitching. Lastly, it is understood that the strap 24 may be attached directly to the primary member 12, forgoing the use of the duality of spools 22a, 22b altogether. For example, the strap 24 may be attached directly to the primary member 12 by means of hook and loop straps, stitching, or a clasp.

A spring urged retraction reel (not shown) may be disposed within each of the duality of spools 22a, 22b that winds to tighten the strap 24, shortening the length of the strap 24 the user may engage with. The reel releases to loosen the strap 24, elongating the length of the strap 24 the user may engage with. Upon use, the strap 24 elongates, affording a user an appropriately lengthened strap 24 that enables the user to place the strap 24 upon the user's shoulder, wherein the shoulder hold 26 directly engages with the shoulder of the user. Non-limiting examples of the purpose of the shoulder hold 26 are that the shoulder hold 26 may be padded to add comfort to the user, or the shoulder hold 26 may be a type of grip to add stability to the user while using the portable carrier 10. Alternatively, when the portable carrier 10 is not in use, the strap 24 retracts into the duality of spools 22a, 22b. The retraction of the strap 24 causes the strap 24 to tautly dispose itself over the top-most portion 20 of the primary member 12 for a hide-away feature. It is understood that a locking mechanism can also be included to lock the reel to maintain a desired length of the strap 24 in use.

Additionally, a plurality of securement straps 30a, 30b is attached to the primary member 12 through slots 31 formed in the primary member 12. The straps 30a, 30b can be formed from nylon with hook and loop ends, leather, and the like, for example. Ends of each of the plurality of straps 30a, 30b may be fastened to each other to form a loop and engage a rail 32 of a ladder 34 when the portable carrier 10 is not in use for a storage feature. Alternatively, the plurality of straps 30a, 30b may also be fastened to engage rung 36 of a ladder 34 when the portable carrier 10 is not in use for an alternative storage feature. Further, the ends of the straps 30a, 30b may be fastened to each other to form the loop and engage the rail 32 of the ladder 34 during use of the portable carrier 10 to further secure the ladder 34. To fasten the ends of the straps 30a, 30b, and conventional fastener may be used such as buttons, snaps, buckles, and the like, for example. It is also understood that the plurality of straps 30a, 30b may be fastened to engage any object, such as hooks on a wall or hooks on a truck or other vehicle during storage. Lastly, it is further understood that a singular strap may be used and that the engagement of straps to the rail 32 of the ladder 34 or the rung 36 of the ladder 34 is not limited to a plurality of straps.

A plurality of hooks 38a, 38b extends outwardly from an anterior face 40 of the primary member 12, each of which has a substantially horizontal planar member 42 with an abutment 44 proximate an end of each of the plurality of hooks 38a, 38b spaced from a rear wall 46. The planar member 42 provides the ladder 34 a sufficient surface to be positioned upon while the abutment 44 prevents the ladder 34 from being displaced or dropped while transported. An apical portion 48 of the rear wall 46 is contoured to form a j-hook 50. The j-hook 50 of each of the plurality of hooks 38a, 38b is fittingly placed between the parallel wall 18 and the posterior face 16 of the primary member 12. The apical portion 48 is positioned over the top-most portion 20 of the primary member 12. The rear wall 46 is configured to abut the anterior face 40 of the primary member 12. Each of the plurality of hooks 38a, 38b is slidingly adjustable. The distance between each of the plurality of hooks 38a, 38b can be varied to facilitate transporting different ladders which may have different dimensions. The distance between each of the plurality of hooks 38a, 38b also distributes the weight of the ladder 34, resulting in the portable carriers 10 being able to consistently achieve a desirable weight distribution of the ladder 34 for the user. The achievement of the desirable weight distribution of the ladder 34 is also supported by the capability the portable carrier 10 to transport the ladder 34 either horizontally or vertically, dependent upon the ladder's 34 respective measurements. In horizontal transportable orientation of the ladder 34, each of the plurality of hooks 38a, 38b engages the rail 32 of the ladder 34. In vertically transportable orientation of the ladder 34, each of the plurality of hooks 38a, 38b engages the rung 36 of the ladder 34. In the embodiment shown, the plurality of hooks 38a, 38b is formed from a metal. However, it is understood that the plurality of hooks 38a, 38b may be formed from any material that is able to sustain the weight of the ladder 34, such as a polymer or an alloy, for example.

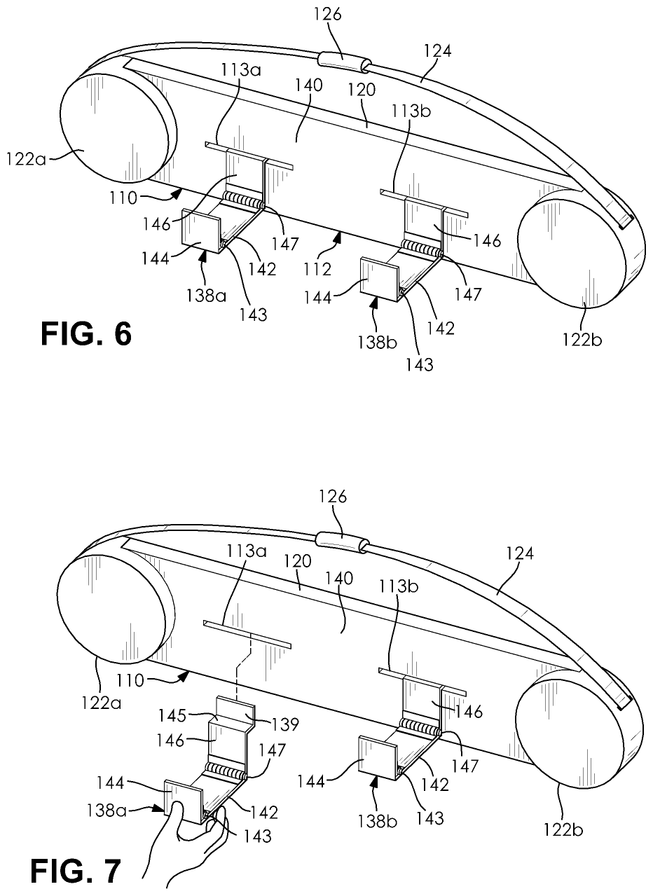

In another embodiment shown in FIGS. 6 and 7, a portable carrier 110 is formed from a primary member 112 inclusive of a plurality of slits 113a, 113b. Each of the plurality of slits 113a,113b is configured to accept a plurality of hooks 138a, 138b that extend outwardly from an anterior face 140 of the primary member 112. However, it is understood that a singular slit may be able to accept the plurality of hooks 138a, 138b as well. The primary member 112 is approximately 18 inches long and six (6) inches wide in the embodiment shown. However, it is understood that the primary member 112 may have any length and/or height. The plurality of hooks 138a, 138b are formed from a metal. However, it is understood that the plurality of hooks 138a, 138b may be formed from any material that is able to sustain the weight of the ladder 34, for example a polymer or an alloy.

The primary member 112 is disposed between a duality of attachable spools 122a, 122b. The duality of spools 122a, 122b house a singular retractable nylon strap 124 inclusive of a shoulder hold 126 that is disposed generally within the middle of the strap 124. However, it is understood that any material may be used to form the strap 124, such as leather or flax. It is also understood that the shoulder hold 126 may be disposed upon any portion along the strap 124 or may be moveable to permit moving the shoulder hold 126 to any point as desired along the strap 124. It is further understood that multiple straps may be used, for example a pair of straps may attach directly to the shoulder hold 126 to form the strap 124 by means of hook and loop straps or stitching. Lastly, it is understood that the strap 124 may be attached directly to the primary member 112, forgoing the use of the duality of spools 122a, 122b altogether. For example, the strap 124 may be attached directly to the primary member 112 by means of hook and loop straps, stitching, or a clasp.

A reel (not shown) is disposed within each of the duality of spools 122a, 122b that winds to tighten the strap 124, shortening the length of the strap 124 the user may engage with. The reel releases to loosen the strap 124, elongating the length of the strap 124 the user may engage with. Upon use, the strap 124 elongates, affording a user an appropriately lengthened strap 124 that enables the user to place the strap 124 upon the user's shoulder, wherein the shoulder hold 126 directly engages with the shoulder of the user. Non-limiting examples of the purpose of the shoulder hold 126 are that the shoulder hold 126 may be padded to add comfort to the user, or the shoulder hold 126 may be a type of grip to add stability to the user while using the portable carrier 110. Alternatively, when the portable carrier 110 is not in use, the strap 124 retracts into the duality of spools 122a, 122b. The retraction of the strap 124 causes the strap 124 to tautly dispose itself over a top-most portion 120 of the primary member 112 for a hide-away feature.

Additionally, a plurality of straps (not shown) is attached to the primary member 112. Each of the plurality of straps may be fastened to engage the rail 32 of the ladder 34 when the portable carrier 110 is not in use for another hide-away feature. Alternatively, the plurality of straps may also be fastened to engage the rung 36 of the ladder 34 by a plurality of straps, such as buttons, snaps, or buckles. It is also understood that the plurality of straps may be fastened to engage any object, such as hooks on a wall or hooks on a truck. Lastly, it is further understood that a singular strap may be used and that the engagement of straps to the rail 32 of the ladder 34 or the rung 36 of the ladder 34 is not limited to a plurality of straps.

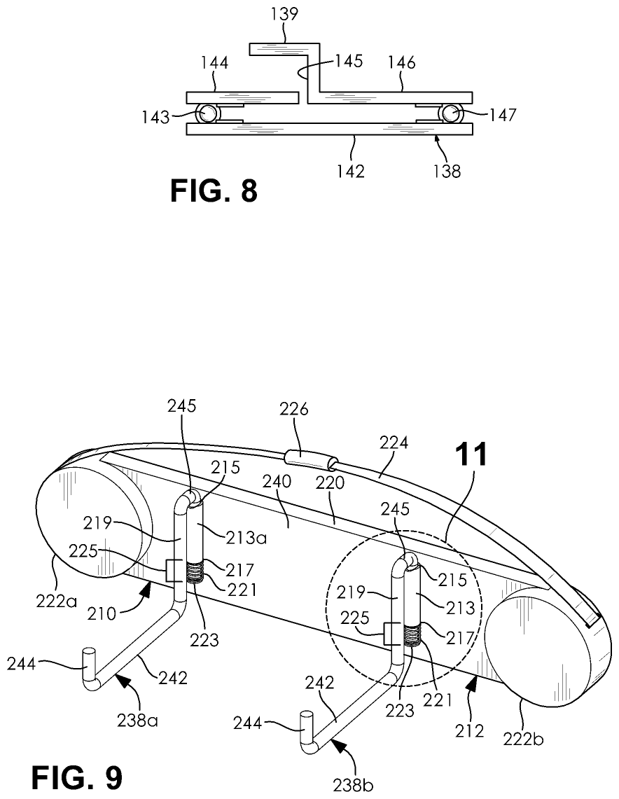

Each of the plurality of hooks 138a, 138b, shown in FIGS. 6-8, is constructed from three (3) corresponding components, a flat plane 142, a rear wall 146 and an abutment 144. The rear wall 146 is attached to a secondary wall 139 by a transversely situated member 145, creating a locking mechanism for whence each of the plurality of hooks 138a, 138b engages each of the plurality of slits 113a, 113b. The secondary wall 139 is placed through either of the plurality of slits 113a, 113b so that the member 145 rests within either of the plurality of slits 113a, 113b and the secondary wall 139 rests against a posterior of the primary member (not shown) while the rear wall 146 rests upon the anterior face 140 of the primary member 112. The rear wall 146 is connected to the flat plane 142 by a hinge 143. The abutment 144 is also connected to the flat plane 142 by a hinge 147. Each hinge 143, 147 allows for each of the plurality of hooks 138a, 138b to fold into itself (retractable) when the portable carrier 110 is not in use, thereupon providing a hide-away feature that is illustrated specifically within FIG. 8. The flat plane 142 provides the ladder 34 a sufficient surface to be positioned upon while the abutment 144 prevents the ladder 34 from being displaced while transported. Each of the plurality of hooks 138a, 138b is slidingly adjustable dependent upon the length of each of the plurality of slits 113a, 113b. The distance between each of the plurality of hooks 138a, 138b can be varied to facilitate transporting different ladders which may have different dimensions. The distance between each of the plurality of hooks 138a, 138b also distributes the weight of the ladder 34, resulting in the portable carrier's 110 capability to consistently achieve a desirable weight distribution of the ladder 34 for the user. The achievement of the desirable weight distribution of the ladder 34 is also supported by the capability the portable carrier 110 has in that the portable carrier 110 is able to transport the ladder 34 either horizontally or vertically, dependent upon the ladder's 34 respective measurements. In the ladder's 34 horizontal transportable orientation, each of the plurality of hooks 138a, 138b engages the rail 32 of the ladder 34. In the ladder's 34 vertically transportable orientation, each of the plurality of hooks 138a, 138b engage the rung 36 of the ladder 34.

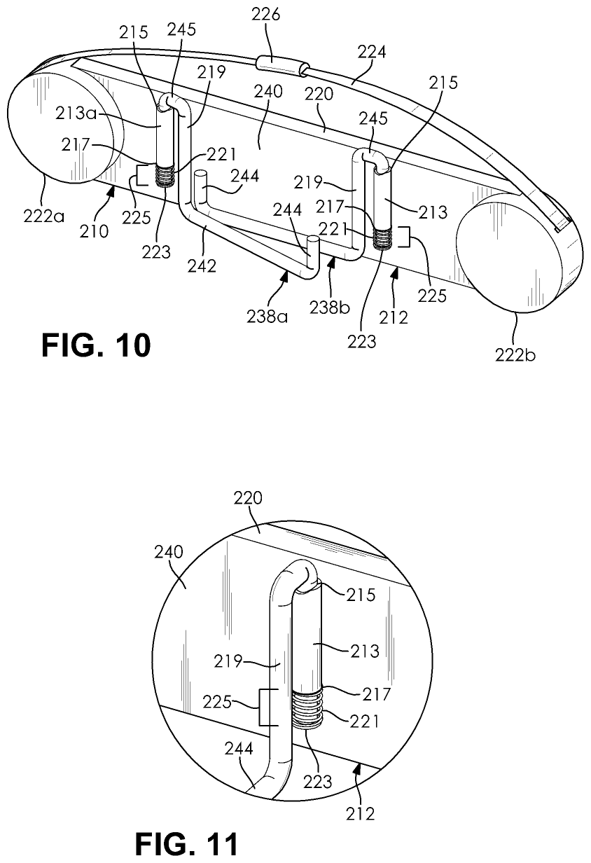

Lastly, in another embodiment shown in FIGS. 9 and 10, a portable carrier 210 is formed from a primary member 212 that is disposed between a duality of attachable spools 222a, 222b. The primary member 212 is approximately 18 inches long and six (6) inches wide in the embodiment shown. However, it is understood that the primary member 212 may have any length and/or height. The duality of spools 222a, 222b house a singular retractable nylon strap 224 inclusive of a shoulder hold 226 that is disposed generally within the middle of the strap 224. However, it is understood that any material may be used to form the strap 224, such as leather or flax. It is also understood that the shoulder hold 226 may be disposed upon any portion along the strap 224 or may be moveable to permit moving the shoulder hold 226 to any point as desired along the strap 224. It is further understood that multiple straps may be used, for example a pair of straps may attach directly to the shoulder hold 226 to form the strap 224 by means of hook and loop straps or stitching. Lastly, it is understood that the strap 224 may be attached directly to the primary member 212, forgoing the use of the duality of spools 222a, 222b altogether. For example, the strap 224 may be attached directly to the primary member 212 by means of hook and loop straps, stitching, or a clasp.

A reel (not shown) is disposed within each of the duality of spools 22a, 22b that winds to tighten the strap 224, shortening the length of the strap 224 the user may engage with. The reel releases to loosen the strap 224, elongating the length of the strap 224 the user may engage with. Upon use, the strap 224 elongates, affording a user an appropriately lengthened strap 224 that enables the user to place the strap 224 upon the user's shoulder, wherein the shoulder hold 226 directly engages with the shoulder of the user. Non-limiting examples of the purpose of the shoulder hold 226 are that the shoulder hold 226 may be padded to add comfort to the user, or the shoulder hold 226 may be a type of grip to add stability to the user. Alternatively, when the portable carrier 210 is not in use, the strap 224 retracts into the duality of spools 222a, 222b. The retraction of the strap 224 causes the strap 224 to tautly dispose itself over a top-most portion 220 of the primary member 212 for a hide-away feature.

Additionally, a plurality of straps (not shown) is attached to the primary member 212. Each of the plurality of straps may be fastened to engage the rail 32 of the ladder 34 when the portable carrier 210 is not in use for another hide-away feature. Alternatively, the plurality of straps may also be fastened to engage the rung 36 of the ladder 34 when the portable carrier 210 is not in use for an alternative hide-away feature. However, it is understood that other material having similarly desirable properties may be used to achieve the proper fastening engagement to the rail 32 of the ladder 34 or to the rungs 36 of the ladder 34 by a plurality of straps, such as buttons, snaps, or buckles. It is also understood that the plurality of straps may be fastened to engage any object, such as hooks on a wall or hooks on a truck. Lastly, it is further understood that a singular strap may be used and that the engagement of straps to the rail 32 of the ladder 34 or the rung 36 of the ladder 34 is not limited to a plurality of straps.

The primary member 212 is weldingly attached to a plurality of cylindrical receptacles 213a, 213b upon an anterior face 240 of the primary member 212. Each of the plurality of cylindrical receptacles 213a, 213b is purposed to receive a plurality of hooks 238a, 238b. More specifically, each of the plurality of cylindrical receptacles 213a, 213b is purposed to accept a downwardly facing portion (not shown) through a top-most portion 215 of either of the plurality of cylindrical receptacles 213a, 213b. The downwardly facing portion protrudes past a bottom-most portion 217 of either of the cylindrical receptacles 213a, 213b. A spring 221 is disposed over a protruding portion 225. A fastener 223 is positioned over the protruding portion 225 of the downwardly facing portion to maintain the spring's 221 disposition. The spring 221 is purposed to accommodate various weights of the ladder 34 and to provide a dampening effect in the instance wherein the ladder 34 is placed upon the plurality of hooks 238a, 238b. However, it is understood that anything capable of producing a dampening effect may be utilized, such as a rubber or a foam. The downwardly facing portion is attached to a parallel portion 219 by a transversely positioned member 245. The parallel portion 219 is contoured to extend to form a flat planar portion 242 that ends in an abutting portion 244. The flat planar portion 242 provides the ladder 34 a sufficient surface to be positioned upon while the abutting portion 244 prevents the ladder 34 from being displaced while transported. Each of the plurality of hooks 238a, 238b may open at any angle to facilitate transporting different ladders which may have different dimensions. The angle which the plurality of hooks 238a, 238b is open also distributes the weight of the ladder 34, resulting in the portable carrier's 110 capability to consistently achieve a desirable weight distribution of the ladder 34 for the user. The achievement of the desirable weight distribution of the ladder 34 is also supported by the capability the portable carrier 110 has in that the portable carrier 210 is able to transport the ladder 34 either horizontally or vertically, dependent upon the ladder's 34 respective measurements. The ladder carrier 210 has the ability to transport the ladder 34 either horizontally or vertically, dependent upon the ladder's 34 respective measurements. In the ladder's horizontal transportable orientation, each of the plurality of hooks 238a, 238b engage the rail 32 of the ladder 34. In the ladder's 34 vertically transportable orientation, each of the plurality of hooks 238a, 238b engage the rung 36 of the ladder 34. Each of the plurality of hooks 238a, 238b has the ability to fold towards the anterior face 240 of the primary member 212 (retractable) when the portable carrier is not in use, thereupon providing a hide-away feature. The plurality of hooks 238a, 238b are formed from metal. However, it is understood that the plurality of hooks 238a, 238b may be formed from any material that is able to sustain the weight of the ladder 34, for example a polymer or an alloy.

It is understood that any rendition of a combination of each of the three aforementioned embodiments may be formed to accomplish the configuration of a portable carrier purposed to transport a ladder. This combination is inclusive of the variety of alternative plurality of hooks utilized within each of the above-described embodiments of the invention.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A portable carrier comprising:
a primary member;
a plurality of hooks coupled to the primary member, the hooks configured to engage a ladder; and
a strap coupled to the primary member, the strap configured to be supported by a shoulder of a user to aid in supporting the ladder.

2. The portable carrier of claim 1, wherein each of the hooks has a substantially horizontal planar member, an abutment proximate a distal end of the hooks, and an apical portion contoured to form a j-hook.

3. The portable carrier of claim 2, wherein the j-hook of each of the hooks is configured cooperate with an upper edge of the primary member and an adjoined parallel wall of the primary member to couple the hooks to the primary member.

4. The portable carrier of claim 3, wherein the hooks are slidingly adjustable.

5. The portable carrier of claim 1, wherein the primary member includes a duality of spools, the duality of spools oppositely arranges on opposing ends of the primary member, at least one of the spools including a reel disposed therein to extend and retract the strap.

6. The portable carrier of claim 1, further comprising a shoulder hold disposed on the strap.

7. The portable carrier of claim 1, further comprising a plurality of straps, wherein each of the straps extends through a pair of slots to couple the strap to the primary member.

8. The portable carrier of claim 1, wherein the hooks are retractable.

9. A portable carrier comprising:
a primary member;
a plurality of hooks coupled to the primary member, the hooks configured to engage a ladder;
a carrier strap coupled to the primary member, the carrier strap configured to be supported by a shoulder of a user to aid in supporting the ladder; and
a plurality of securement straps coupled to the primary member to aid in storage of the portable carrier or further securement of the ladder to the carrier.

10. The portable carrier of claim 9, wherein each of the securement straps extends through a pair of slots to couple the securement straps to the primary member

11. The portable carrier of claim 9, wherein each of the plurality of hooks has a flat plane, a peripheral wall, and an abutment, wherein the peripheral wall is attached to a secondary wall by a transversely situated member, and wherein the peripheral wall and the abutment are both hingingly supported by the flat plane.

12. The portable carrier of claim 11, wherein the secondary wall of each of the hooks is placed in a slit formed in the primary member so the transversely situated member rests within the slit, thereby creating a locking mechanism that maintains a position of the hooks.

13. The portable carrier of claim 9, wherein each of the hooks has a substantially horizontal planar member, an abutment proximate a distal end of the hooks, and an apical portion contoured to form a j-hook.

14. The portable carrier of claim 13, wherein the j-hook of each of the hooks is configured cooperate with an upper edge of the primary member and an adjoined parallel wall of the primary member to couple the hooks to the primary member.

15. The portable carrier of claim 9, wherein the primary member includes a duality of spools, the duality of spools oppositely arranged on opposing ends of the primary member, at least one of the spools including a reel disposed therein to extend and retract the carrier strap.

16. A portable carrier comprising:
a primary member having opposing ends;
a plurality of hooks coupled to the primary member, the hooks configured to engage a ladder;
a carrier strap coupled to the primary member, the carrier strap configured to be supported by a shoulder of a user to aid in supporting the ladder; and
a duality of spools oppositely arranged on the opposing ends of the primary member, at least one of the spools including a reel disposed therein to extend and retract the carrier strap.

17. The portable carrier of claim 16, further comprising a plurality of securement straps coupled to the primary member to aid in storage of the portable carrier or further securement of the ladder to the carrier.

18. The portable carrier of claim 16, wherein the hooks are retractable.

19. The portable carrier of claim 16, wherein each of the plurality of hooks has a flat planar portion, an abutting portion, a parallel portion, and a downwardly facing portion wherein the parallel portion is attached to the downwardly facing portion by a transversely positioned member.

20. The portable carrier of claim 19, wherein the downwardly facing portion is inserted through either of the cylindrical receptacles through the top-most portion and protrudes past the bottom-most portion, whereupon a spring is disposed over a protruding portion, whereupon a fastener is positioned over the protruding portion of the downwardly facing portion.
